(19) United States
(12) Patent Application Publication
(10) Pub. No.: US 2010/0207898 A1
(43) Pub. Date: Aug. 19, 2010

(54) MOBILE TERMINAL AND METHOD FOR GENERATING THE EMBEDDED DRAWING DATA BASED ON FLASH IMAGE

(75) Inventor: Young Muk Cha, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: MOBIDERS, INC., Seoul (KR)

(21) Appl. No.: 12/680,027

(22) PCT Filed: Jun. 30, 2008
(86) PCT No.: PCT/KR08/03837

§ 371 Date: Mar. 25, 2010

(30) Foreign Application Priority Data
Oct. 16, 2007 (KR) 10-2007-0103888

(51) Int. Cl. G06F 3/048; G06F 3/041; G06F 3/14

(52) U.S. Cl. 345/173; 715/211; 715/841

(57) ABSTRACT

The present invention relates to a mobile terminal and the method for generating embedded drawing data based on flash imagery, which is capable of generating a multimedia message or a flash image that is various, active and interesting, by connecting the movement so as to move the object which is designated according to the arbitrary drawn trace, while drawings or writings that are drawn with pen on the touch screen can be seen again. It has an effect in that it is able to deliver amusement and information by communicating between mobile terminals, by transmitting to other mobile terminals through a wire net and a wireless net, by sending or using e-mail, and by uploading to the internet board. A mobile terminal according to the present invention includes an input unit that receives one or more among a shape change request signal or a location change request signal with respect to one of either an image, a redrawing object, or a stamp displayed on a display unit of the mobile terminal from a user; a controller that manufactures the scene in which one of either the image, the redrawing object, or the stamp changes according to one or more among the shape change request signal or the location change request signal with a flash image; and a memory unit that stores the flash image transformed by the controller.

### TECHNICAL FIELD

The present invention relates to a mobile terminal and the method for generating embedded drawing data based on flash imagery, and more particularly, for generating a multimedia message or a flash image that is various, active and interesting, by connecting the movement to on object so as to move the object, which is designated according to the arbitrarily drawn locus, while drawings or writings that are drawn with pen on the touch screen can be seen again on other mobile terminals in the order of the drawings.

### BACKGROUND ART

Usually, the mobile terminal provides the animation image and the vector image data manufactured in advance. Here, a problem exists because the mobile terminal cannot be used to manufacture the UCC (User Manufacture Contents) by connection to movement and it is impossible to see drawings again in the order of the drawings.

### DISCLOSURE

### Technical Problem

The invention has been designed to solve the above-mentioned problems. It is an object of the invention to provide a mobile terminal and the method for generating embedded drawing data based on flash imagery, which is capable of generating a multimedia message or a flash image that is various, active and interesting, by connecting the movement to on object so as to move the object, which is designated according to the arbitrarily drawn locus, while drawings or writings that are drawn with pen on the touch screen can be seen again on other mobile terminals in the order of the drawings.

### Technical Solution

In order to achieve the above-mentioned object, according to an aspect of the invention, provided is a mobile terminal including an input unit that receives one or more among a shape change request signal or a location change request signal with respect to one of either an image, a redrawing object, or a stamp displayed on a display unit of the mobile terminal from a user; a controller that manufactures the scene in which one of either the image, the redrawing object, or the stamp changes according to one or more among the shape change request signal or the location change request signal with a flash image; and a memory unit that stores the flash image transformed by the controller.

The image is an image file that is stored in the memory unit and is uploaded by the user. The redrawing object is drawn by the user on the display unit as a square, a circle, a line or a text, or is manufactured in advance and stored in the memory unit to be uploaded by the user. The stamp is an icon file, which is stored in the memory unit and is uploaded by the user. The input unit includes a key input unit or a touch screen. The shape change request signal is an object size change request signal.

The location change request signal is one or more signals among a signal that moves the image, the redrawing, or the stamp according to a specific locus that the user inputted through the input unit; a signal that moves the location of the image, the redrawing, or the stamp on the display unit to the location that the user inputted; a signal that rotates the image, the redrawing, or the stamp; or a signal that shuttles the image, the redrawing, or the stamp to a specific location which the user sets up.

In accordance with an aspect of the invention, a picture that is uploaded by the user after being photographed in an additional camera unit or in an idle screen is displayed on the display unit on which the image, the redrawing, or the stamp is to be displayed.

The data of the redrawing object has the structure in which data for storing a circle or a square, a circle, a straight line, a curve with coordinates values according to the order of the drawings, data for storing a locus among the location change request signal, and data for storing text that the user inputted through the input unit are connected to each other with a list structure. The flash image includes a DMF (Digital Mobile Flash) format image or a VIS (Vector Image Solution) format image.

In accordance with an aspect of the invention, an embodiment of the mobile terminal further includes a transceiver for the transmission of the wireless transmission between mobile terminals.

According to another aspect of the invention, provided is a method for generating embedded drawing data based on flash imagery by using a mobile terminal, which includes the steps of (a) receiving one or more among a shape change request signal or a location change request signal for one of either an image, a redrawing object, or a stamp displayed on a display unit of the mobile terminal from a user; (b) manufacturing the scene in which one of either the image, the redrawing object, or the stamp changes according to one or more among the shape change request signal or the location change request signal with a flash image; and (c) storing the transformed flash image in a memory unit.

In case the step (a) is related to the image, before the step (a), an embodiment of the method for generating embedded drawing data based on flash imagery by using a mobile terminal further includes the step (a-1) of uploading the image to the display unit after the user selects the image stored in the memory unit.

In case the step (a) is related to the redrawing, before the step (a), an embodiment of the method for generating embedded drawing data based on flash imagery by using a mobile terminal further includes the steps of: (a-2) selecting one or more drawing tools among a circle, a square, a line or a text in a submenu displayed on the display unit by the user; (a-3) drawing a drawing object by the user through an input unit; (a-4) storing location information and size information of the drawing object in the memory unit; and (a-5) converting the drawn drawing object, the location information and the size information into a redrawing object to store in the memory unit.

In case the step (a) is related to the stamp, before the step (a), an embodiment of the method for generating embedded drawing data based on flash imagery by using a mobile terminal further includes the step (a-6) of selecting the stamp stored in the memory unit by the user and displaying it on the display unit.

The manufacturing with a flash image in the step (b) includes the steps of: (b-1) converting the generated image object, the redrawing object or the stamp object into flash image tags; (b-2) calculating the size information from the converted flash image tags so as to manufacture the flash image header; and (b-3) storing the flash image header and the flash image tags in the memory unit.

In case the redrawing object is plural, the redrawing objects, which are converted to the flash image tags of the stored flash image, are stored in the memory unit, respectively, in such a manner that each of them is positioned in a different layer. The shape change request signal is an object size change request signal.

The location change request signal is one or more signals among a signal that moves the image, the redrawing, or the stamp according to a specific locus that the user inputted through an input unit; a signal that moves the location of the image, the redrawing, or the stamp on the display unit to the location that the user inputted; a signal that rotates the image, the redrawing, or the stamp; or a signal that shuttles the image, the redrawing, or the stamp to a specific location which the user sets up.

### ADVANTAGEOUS EFFECTS

According to an embodiment of present invention, the mobile terminal and the method for generating embedded drawing data based on flash imagery is able to generate a multimedia message or a flash image that is various, active and interesting, by connecting the movement so as to move the object, which is designated according to the arbitrary drawn trace, while drawings or writings that are drawn with pen on the touch screen can be seen again. It has an effect in that it is able to deliver amusement and information by communicating between mobile terminals, by transmitting to other mobile terminals through a wire net and a wireless net, by sending or using e-mail, and by uploading to the internet board.

### BRIEF DESCRIPTION OF THE DRAWINGS

FIG. 1 is a block diagram showing a mobile terminal including the function for generating embedded drawing data based on flash imagery according to an embodiment of the present invention.

FIG. 2 shows the menu of a mobile terminal according to an embodiment of the present invention.

FIG. 3 shows the functional structure of the menu shown in FIG. 2.

FIG. 4 shows the flow of the image function using an image object of FIG. 3.

FIGS. 5 to 7 show the embodiment of drawing the locus so as to connect the movement to the selected image by using the image function of FIG. 4 and the process where the selected image moves according to the locus.

FIG. 8 shows the flow of the redrawing function using the circle, the square, and the line object of FIG. 3.

FIG. 9 shows the example of connecting the movement to the redrawing object, which is drawn by using the circle, the square, and the line object, by using the redrawing function of FIG. 8.

FIGS. 10 to 12 show the process of connecting the movement so as to rotate clockwise after drawing the flower shape by using the redrawing function of FIG. 8

FIG. 13 shows the example of performing the movement in such a manner that the sun moves from side to side while the size of the heart and the whisker is changed after drawing the sun, the heart, and the whisker by using the redrawing function of FIG. 8.

FIG. 14 shows the structure of the redrawing object.

FIGS. 15 to 16 show the data structure and the use example of the redrawing object.

FIG. 17 shows the flow of the stamp function using the stamp object of FIG. 3.

FIGS. 18 to 19 show the example of drawing the locus so as to perform the movement after copying the fallen leaves shape stamp to the display unit by using the stamp function of FIG. 17, and the process where the stamp moves according to the locus.

FIG. 20 shows the flow of the flash image storage function of FIG. 3.

FIG. 21 shows the layer structure of embedded drawing data based on flash imagery.

### BEST MODE

Firstly, the term used in this document will be defined. In the mobile terminal, the image function for establishing embedded drawing data by using an image is the function that selects an image, and connects the movement to the selected image for storage so as to move the selected image according to the locus drawn.

The redrawing function for establishing embedded drawing data by using the redrawing object is the function that stores the information of the circle, the square, the line drawn with pen in the touch screen, and the inputted text information as a redrawing object so as to re-draw, and connects the movement for storage so as to move the stored redrawing object according to the locus.

The stamp function for establishing embedded drawing data by using an image is the function of repeatedly copying the image or the flash image selected in the display unit by using either the image made in advance or the flash image made in advance and connecting the movement to the displayed image or flash image for storage so as to move the displayed image or flash image according to the locus.

The flash image storage function is the function that transforms the stored object into the tag that forms the flash image, and calculates the size information by using the transformed tag, and stores the flash image header which includes the size information and the transformed tag so as to make the flash image.

Hereinafter, the preferred embodiment of a mobile terminal and the method for generating an embedded drawing data based on flash imagery according to the present invention will be illustrated in detail with reference to drawings. Elements of the same construction or function are provided with the same reference numerals in the specification.

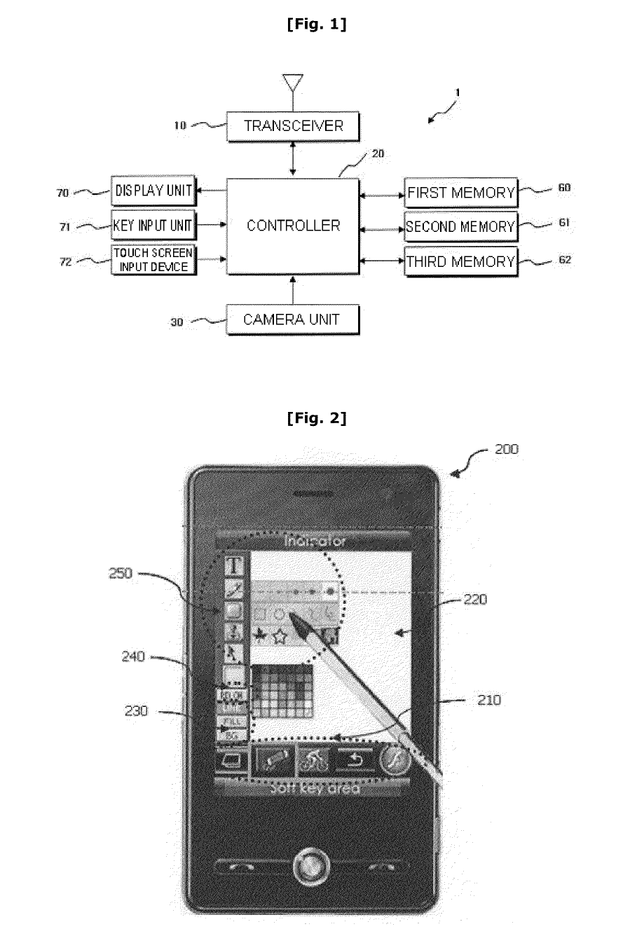

As shown in FIG. 1, the mobile terminal of the present invention comprises an input unit including a key input unit 71, and a touch screen input device 72; a controller 20 a memory unit including a controller 20, a first memory 60, a second memory 61, and a third memory 62; a transceiver 10; and a display unit 70.

The input unit receives at least one of the shape change request signal or the location change request signal for one of an image, a redrawing object, or a stamp displayed on the display unit 70 of the mobile terminal. Here, on the display unit 70 on which the image, the redrawing, or the stamp is to be displayed, an idle screen or the picture which is uploaded by an user after being photographed in an additional camera unit is displayed.

The image displayed on the display unit 70 is the image file that is stored in the memory and uploaded by the user. The redrawing object is the file that is drawn by user on the display unit 70 with the square, the circle, the line or the text, or the file that is manufactured in advance and stored in the memory and is uploaded by the user. The stamp is the icon file, which is stored in the memory and is uploaded by the user. The image file uploaded by the user can be the image, which is photographed by the additional camera unit.

In the meantime, the shape change request signal is the object size change request signal.

The location change request signal is one or more signals among a signal that moves the image, the redrawing, or the stamp according to a specific locus, which the user inputted through the input unit; a signal that moves the location of the image, the redrawing, or the stamp on the display unit 70 to the location that the user inputted; a signal that rotates the image, the redrawing, or the stamp; or a signal that shuttles the image, the redrawing, or the stamp to a specific location which the user sets up.

In the meantime, the controller 20 manufactures the scene that the image, the redrawing, or the stamp is changed to according to one or more among the shape change request signal or the location change request signal by using an additional flash image manufacturing program. In the memory, the flash image transformed by the controller 20, the image, the stamp, and the redrawing object, which is manufactured in advance, are stored. The transceiver transmits or wirelessly transmits data between the mobile terminals.

The display unit 70 displays only a main menu 210 in an initial stage in order to be suitable for a small screen. If the designated button is selected in the main menu, the related submenus 230, 240, and 250 are indicated on the display unit 210 and the various designated functions is performed.

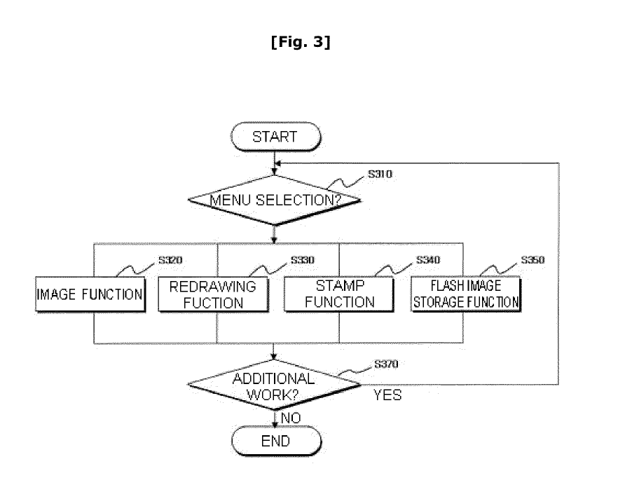

As shown in FIG. 3, the major function of the main menu and the submenu can be divided into the image function S320, the redrawing function S330, the stamp function S340, and the flash image storage function S350 according to the selected menu S310, while the function can be repeatedly performed S370.

Hereinafter, the method for generating embedded drawing data based on a flash image by using a mobile terminal will be explained.

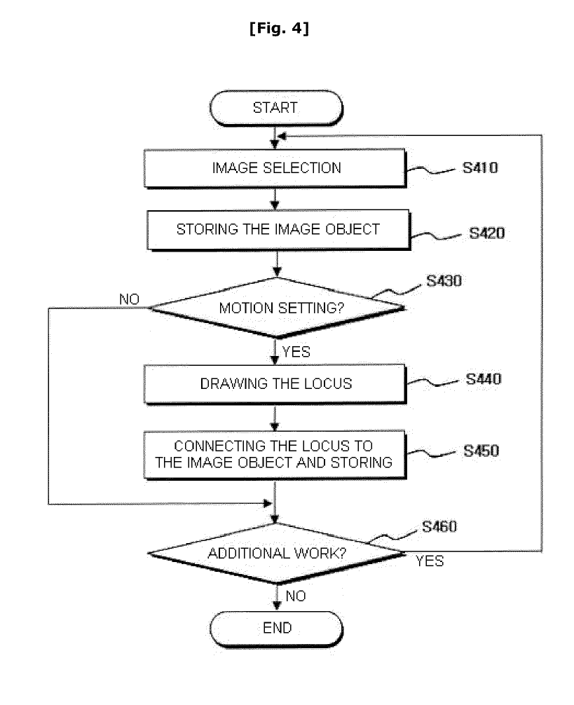

Firstly, the image function for making the image object that is the embedded drawing data by using an image, as shown in FIG. 4, selects the image stored in a first memory S410, and stores it in a second memory as an image object S420 after requesting the signal which changes the size or the location of the image or rotates the image to the controller 20.

When the image object is set to be moved S430, the signal for moving the image object according to the locus which is drawn with pen on the touch screen S440, or for selecting the motion, which is designated in the menu in advance, for example, the shuttle motion to a specific point, is requested to the controller 20.

Thus, the controller 20 stores the signal including the drawn locus or the selected motion in the second memory with connection to the image object S450.

Due to the step S450, the controller 20 stores together the successive coordinate value for the locus or the selected motion and the image object so that the flash image in which the image object moves according to the successive coordinate for the locus, can be manufactured. Subsequently, in case the user desires to work on the other image, it should be started again from the image selection S460.

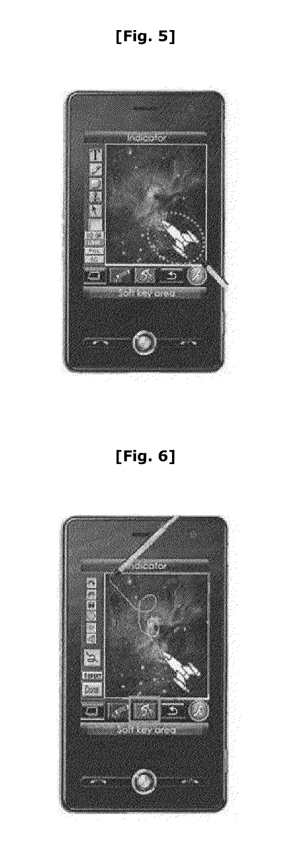

FIGS. 5 to 7 show the embodiment for drawing the locus so as to connect the movement to the selected image by using the image function of FIG. 4 and the process where the selected image moves according to the locus.

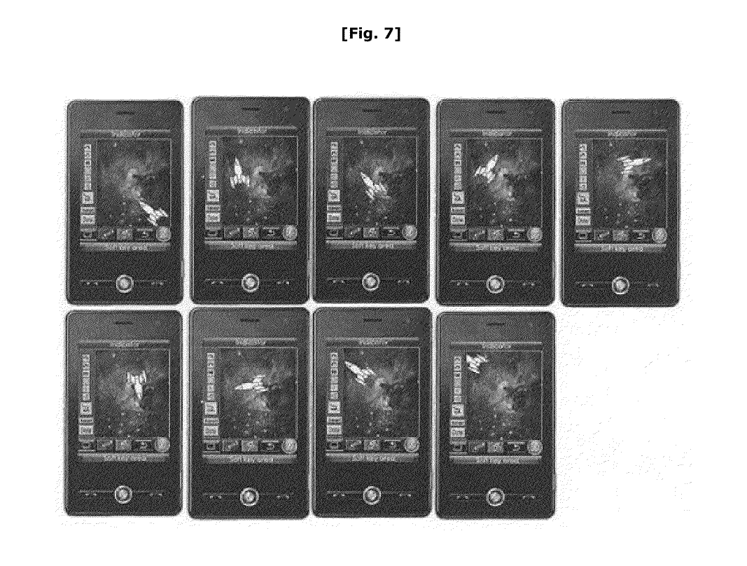

FIG. 5 is a drawing in which the image is selected and displayed on a screen. FIG. 6 shows the process of connecting the movement to the selected image by drawing the locus with pen on the touch screen. FIG. 7 shows the process where the selected image moves according to the drawn locus.

In the meantime, the redrawing function of making the redrawing object, which is embedded drawing data by using a redrawing, is a function that shows the circle or the square, the line, and the text on the display unit 70 in order of the drawings or inputs the circle or the square, the line, and the text drawn on the touch screen.

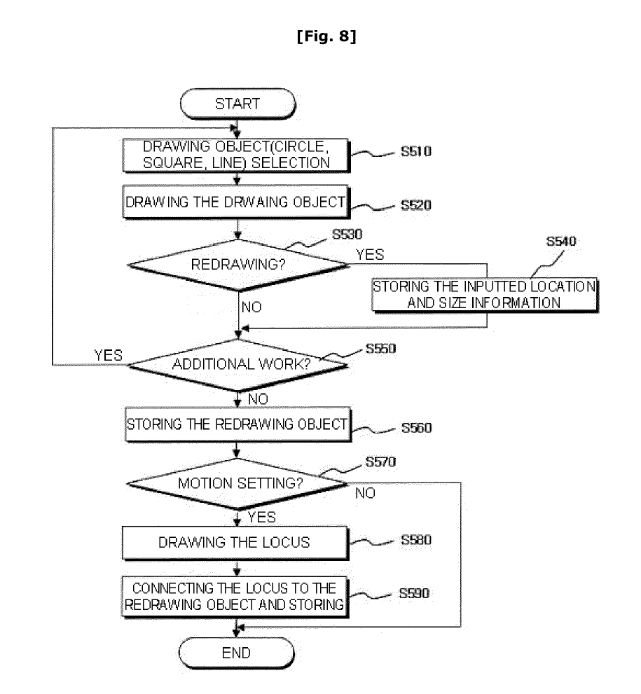

As shown in FIG. 8, the drawing object of the circle or the square, the line, and the text is selected in the submenu displayed on the display unit 70 S510, and the drawing object is drawn on the touch screen S520. In case the redrawing function is set up S530, the signal for changing the size or the location of the drawing object or rotating the drawing object is requested to the controller 20, and is stored in the second memory S540.

And, if the drawing object is not inserted any more S550, the drawing object drawn in the display unit 70, the location information, and the size information are stored in the second memory as a redrawing object S560.

When the redrawing object is set to be moved S570, the signal for moving the redrawing object according to the locus which is drawn with pen on the touch screen S580, or for selecting the motion, which is designated in the menu in advance, for example, the shuttle motion to a specific point, is requested to the controller 20. Subsequently, the controller 20 connects the drawn locus or the selected motion to the redrawing object and stores it in the second memory S590.

Due to the step S590, the controller 20 stores together the successive coordinate value for the locus or the selected motion and the redrawing object so that the flash image in which the redrawing object moves according to the successive coordinate for the locus, can be manufactured.

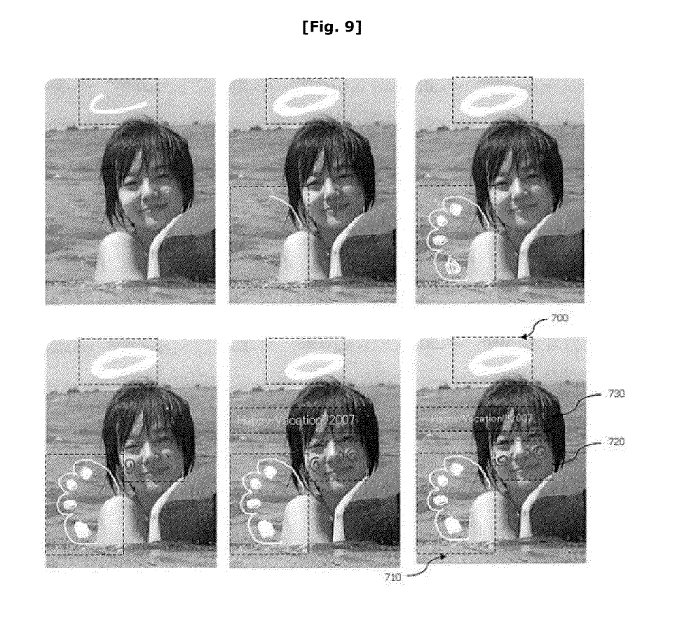

FIG. 9 shows the example of connecting the movement to the redrawing object, which is drawn by using the circle, the square, and the line object.

In detail, as to the rectangular region 700 of FIG. 9, a circle is drawn with pen, and the motion that shows the circle becomes smaller and bigger after the re-drawing of the circle is connected, while the rectangular region 710 indicates the connection of motion so as to re-draw the wing. The rectangular region 720 indicates the connection of motion so as to rotate after re-drawing the helix line. The rectangular region 730 indicates the connection of motion in order that the inputted text becomes smaller and bigger.

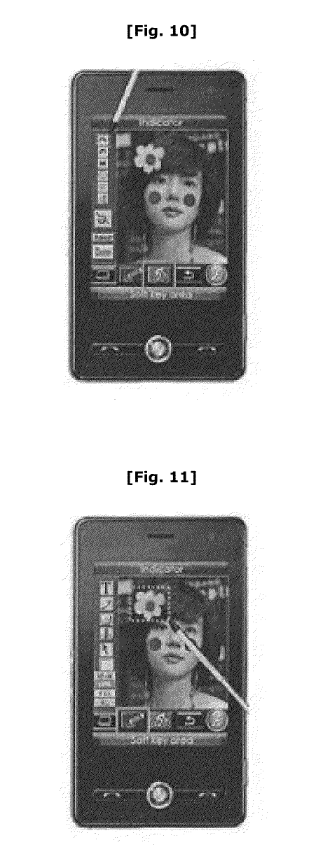

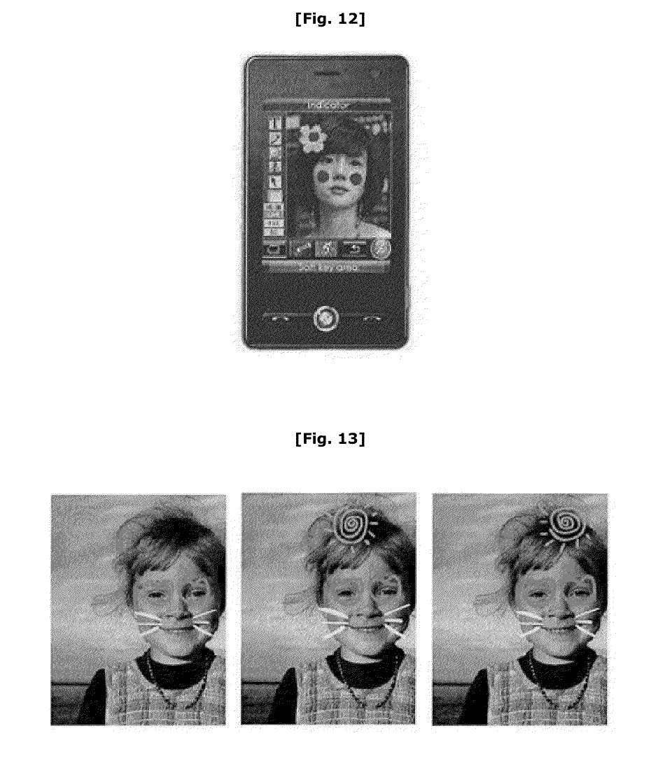

FIGS. 10 to 12 show the process of connecting the movement so as to rotate clockwise after drawing the flower shape. That is, FIG. 10 shows the flower shape, which is drawn with pen on the touch screen, FIG. 11 shows the process in which the rotation motion is connected in order that the drawn flower shape is rotated, and FIG. 13 shows that the flower shape is rotated.

FIG. 13 shows the example of performing the movement in such a manner that the sun moves from side to side while the size of the heart and the whisker is changed after drawing the sun, the heart, and the whisker.

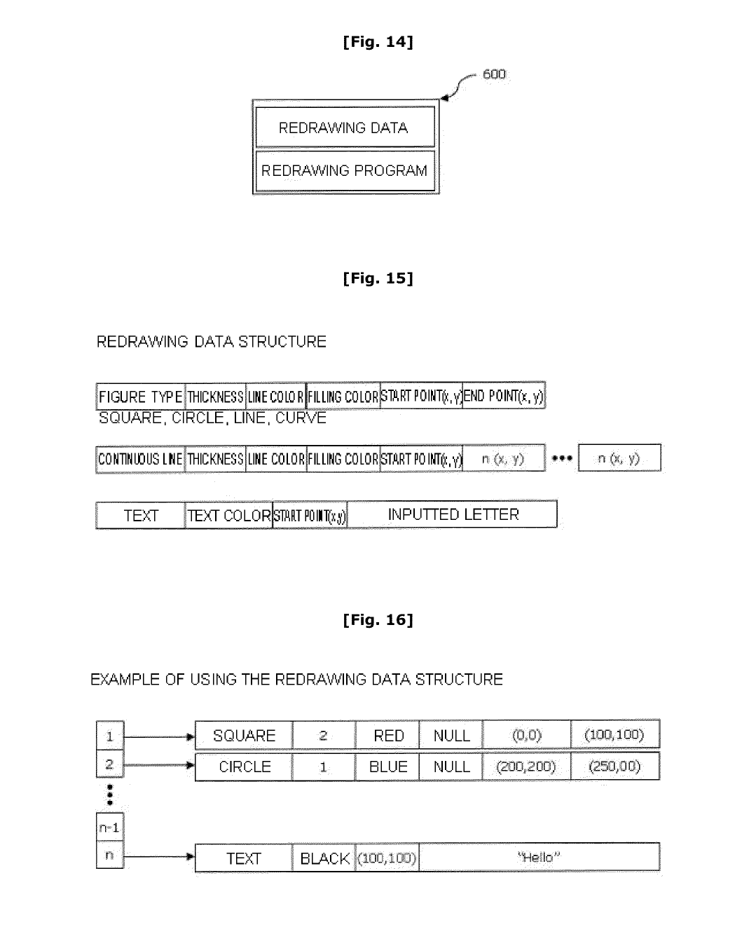

As shown in FIG. 14, the structure 600 of the redrawing object is comprised of redrawing data and a redrawing program in order to perform the redrawing function. As shown in FIG. 15, the redrawing data has the structure that connects a data structure for storing a circle or a square, a straight line, a curve, a text as coordinates values according to the order of the drawing or the inputting, a data structure for storing the locus or the selected motion, and a data structure for storing the text with the list structure to manage.

The redrawing program is a program that is composed of the commands of the text base in order to indicate in the display unit 70 by using the data stored in the redrawing data. When storing the flash image, the redrawing data is stored with the identical structure. That is, the redrawing data is transformed to the flash image tags including the redrawing data, while the redrawing program is copied to the program region of the flash image tags and stored.

FIG. 16 shows the data such as the square, the circle, and the text stored in the redrawing data structure.

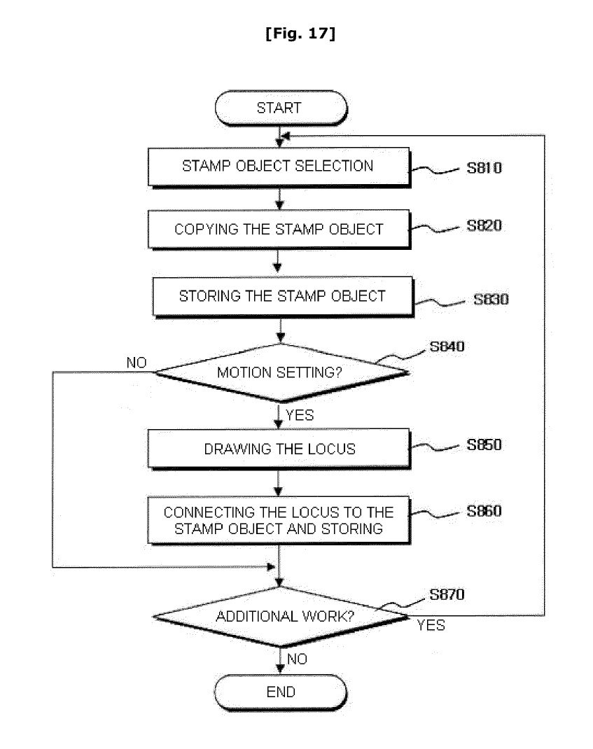

In the meantime, in manufacturing the stamp object, which is an embedded drawing data, by using the stamp as a stamp function as shown in FIG. 17, the stamp object that is stored in the first memory is selected S810, and the selected stamp object is copied to the display unit 70 S820, thereafter, being stored in the second memory S830.

Here, after further requesting the signal to change the size or the location of the stamp object or to rotate the stamp object to the controller 20, the stamp object can be stored in the second memory. When the stamp object is set to be moved S840, the signal for moving the stamp object according to the locus which is drawn with pen on the touch screen S850, or for selecting the motion, which is designated in the menu in advance, for example, the shuttle motion to a specific point, is requested to the controller 20.

Thus, the controller 20 connects the drawn locus or the selected motion to the stamp object and stores it in the second memory S860.

Due to the step S860, the controller 20 stores together the successive coordinate value for the locus or the selected motion and the stamp object so that the flash image in which the stamp object moves according to the successive coordinate for the locus, can be manufactured. Then, in case of further adding the stamp object, it starts again from the stamp object selection S870.

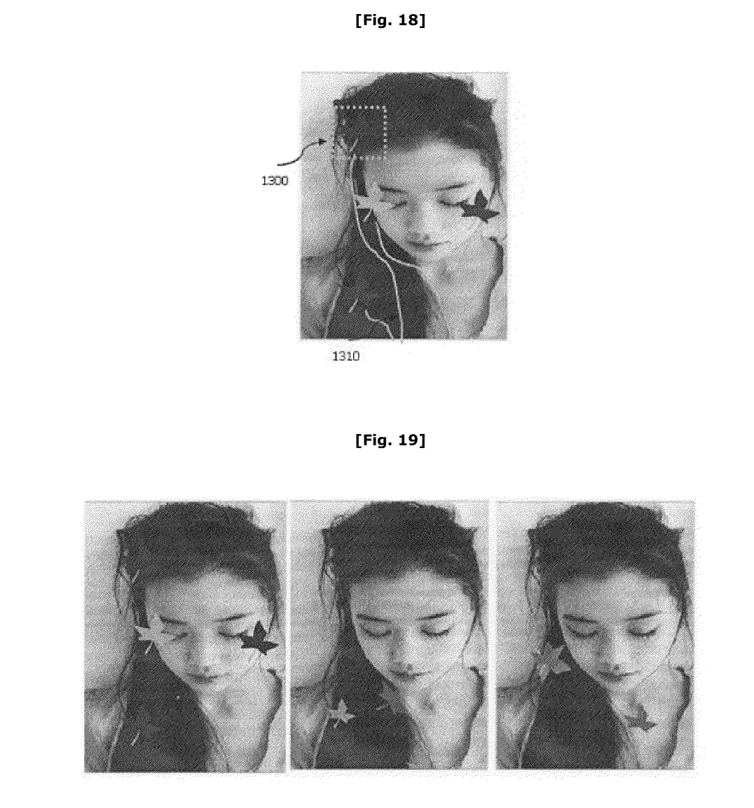

FIGS. 18 to 19 show the example of drawing the locus so as to perform the movement after copying the fallen leaves shape stamp to the display unit by using the stamp function of FIG. 17 and the process where the stamp moves according to the locus.

In detail, FIG. 18 shows that the selected fallen leaves stamp object is copied to be displayed on the screen (1300) and the locus is drawn (1310) to be connected to the copied stamp object. FIG. 19 shows the stamp object which moves according to the locus.

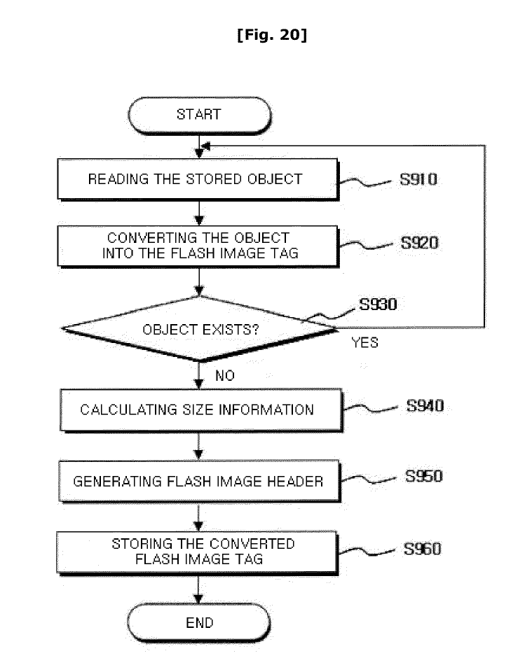

As shown in FIG. 20, in storing the manufactured image object, the redrawing object, and the stamp object as a flash image, one of the image object, the redrawing object, and the stamp object is read S910, which is converted into the flash image tags S920. Such a process is repeated until the stored object does not exist anymore S930.

The size information is calculated from the tag, which is transformed in order to make the flash image header S940. Then, in order to make the flash image, the flash image header is stored in the third memory S950 and the transformed tag of each object is stored in the third memory S960.

In the meantime, in converting the redrawing object among the stored object into the flash image tags, the redrawing data of the redrawing object is converted into the flash image tags including the redrawing data, while the redrawing program copies and stores the redrawing data into the program region of the flash image tags.

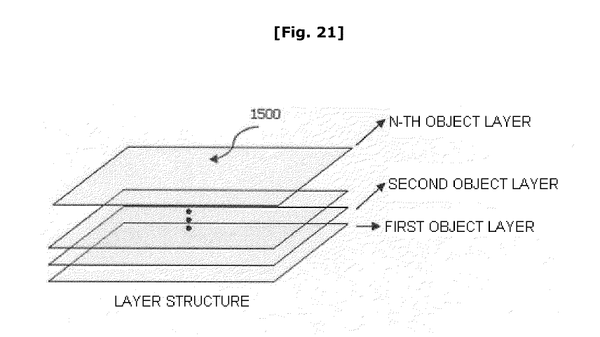

As shown in FIG. 21, when the object transformed to each flash image tags included in the flash image is plural, the redrawing objects which are transformed to the flash image tags of the stored flash image are stored in the memory unit in such a manner that each of them is positioned in a different layer. Therefore each redrawing object is overlapped when moving to make a natural and dynamic effect and the order of displaying on the screen can be changed. In addition, the object can be independently selected and edited.

By using the DMF (Digital Mobile Flash) format tag which is the vector image, like the flash image, and the VIS (Vector Image Solution) format tag, the function of converting the stored object into the flash image tags and storing the flash image can manufacture the DMF image or the VIS image.

The present invention can be used for a mobile terminal, which generates embedded drawing data based on flash imagery.

### INDUSTRIAL APPLICABILITY

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal comprising:
an input unit that receives at least one of a shape change request signal or a location change request signal with respect to one of an image, a redrawing object, or a stamp displayed on a display unit of the mobile terminal from a user;
a controller that manufactures a scene in which one of the image, the redrawing object, or the stamp changes according to at least one of the shape change request signal or the location change request signal with a flash image; and
a memory unit that stores the flash image transformed by the controller.

2. The mobile terminal of claim 1, wherein the image is an image file, which is stored in the memory unit and is uploaded by the user.

3. The mobile terminal of claim 1, wherein the redrawing object is drawn by the user on the display unit as a square, a circle, a line or a text, or is manufactured in advance and stored in the memory unit to be uploaded by the user.

4. The mobile terminal of claim 1, wherein the stamp is an icon file, which is stored in the memory unit and is uploaded by the user.

5. The mobile terminal of claim 1, wherein the input unit includes a key input unit or a touch screen.

6. The mobile terminal of claim 1, wherein the shape change request signal is an object size change request signal.

7. The mobile terminal of claim 1, wherein the location change request signal is one or more signals among a signal that moves the image, the redrawing, or the stamp according to a specific locus that the user inputted through the input unit; a signal that moves the location of the image, the redrawing, or the stamp on the display unit to the location that the user inputted; a signal that rotates the image, the redrawing, or the stamp; or a signal that shuttles the image, the redrawing, or the stamp to a specific location which the user sets up.

8. The mobile terminal of claim 1, wherein a picture that is uploaded by the user after being photographed in an additional camera unit or an idle screen is displayed on the display unit on which the image, the redrawing, or the stamp is to be displayed.

9. The mobile terminal of claim 1, wherein the data of the redrawing object has the structure in which data for storing a circle or a square, a circle, a straight line, a curve with coordinate values according to the order of drawing, data for storing a locus among the location change request signal, and data for storing a text that the user inputted through the input unit are connected each other with a list structure.

10. The mobile terminal of claim 1, wherein the flash image includes a DMF (Digital Mobile Flash) format image or a VIS (Vector Image Solution) format image.

11. The mobile terminal of claim 1, further comprising a transceiver for the transmission or the wireless transmission between mobile terminals.

12. A method for generating embedded drawing data based on flash imagery by using a mobile terminal, the method comprising the steps of:
(a) receiving at least one of a shape change request signal or a location change request signal for one of an image, a redrawing object, or a stamp displayed on a display unit of the mobile terminal from a user;
(b) manufacturing a scene in which one of the image, the redrawing object, or the stamp changes according to at least one of the shape change request signal or the location change request signal with a flash image; and
(c) storing the transformed flash image in a memory unit.

13. The method of claim 12, in case the step (a) is related to the image, before the step (a), further comprising the step (a-1) of uploading the image to the display unit after the user selects the image stored in the memory unit.

14. The method of claim 12, in case the step (a) is related to the redrawing, before the step (a), further comprising the steps of:
(a-2) selecting one or more drawing tools among a circle, a square, a line, or a text in a submenu displayed on the display unit by the user;
(a-3) drawing a drawing object by the user through an input unit;
(a-4) storing location information and size information of the drawing object in the memory unit; and
(a-5) converting the drawn drawing object, the location information and the size information into a redrawing object to be stored in the memory unit.

15. The method of claim 12, in case the step (a) is related to the stamp, before the step (a), further comprising the step (a-6) of selecting the stamp stored in the memory unit by the user and displaying it on the display unit.

16. The method of claim 12, manufacturing with a flash image in the step (b) comprises the steps of:
(b-1) converting the generated image object, the redrawing object or the stamp object into flash image tags;
(b-2) calculating the size information from the converted flash image tags so as to manufacture the flash image header; and
(b-3) storing the flash image header and the flash image tags in the memory unit.

17. The method of claim 12, wherein, in case the redrawing object is plural, the redrawing objects, which are converted to the flash image tags of the stored flash image, are stored in the memory unit respectively in such a manner that each of them is positioned in a different layer.

18. The method of claim 12, wherein the shape change request signal is an object size change request signal.

19. The method of claim 12, wherein the location change request signal is one or more signals among a signal that moves the image, the redrawing, or the stamp according to a specific locus that the user inputted through an input unit; a signal that moves the location of the image, the redrawing, or the stamp on the display unit to the location that the user inputted; a signal that rotates the image, the redrawing, or the stamp; or a signal that shuttles the image, the redrawing, or the stamp to a specific location which the user sets up.
